(19) United States
(12) Patent Application Publication
(10) Pub. No.: US 2008/0157967 A1
(43) Pub. Date: Jul. 3, 2008

(54) RFID INVENTORY DEVICE

(75) Inventors: Andrew R. Jones, Round Rock, TX (US); Gregory J. Boss, American Fork, UT (US); Donnie A. Smith, Raleigh, NC (US); Rick A. Hamilton, Charlottesville, VA (US); Kevin C. McConnell, Austin, TX (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/617,002

(22) Filed: Dec. 28, 2006

(51) Int. Cl. G08B 13/14

(52) U.S. Cl. 340/572.1

(57) ABSTRACT

A radio frequency identification (RFID) inventory device attached to a container for tracking quantities of objects stored in the container having an antenna supporting wireless interrogation by an external RFID reader, a RFID chip coupled to the antenna having an embedded unique identifier and a memory element, where the RFID chip is adapted to store in the memory element at least one quantity value and to allow an external reader to wirelessly collect the identifier and at least one quantity value in response to said wireless interrogation, and one or more sensors coupled to the RFID chip, where the sensors are configured to send at least one signal to the RFID chip in response to a change in quantities of objects in the container and where the RFID chip is configured to update at least one quantity value stored in response to a signal from the sensors.

### FIELD OF THE INVENTION

The present invention is related to the field of inventory devices and methods and more particularly, to an RFID inventory device and use thereof.

### BACKGROUND OF THE INVENTION

Radio frequency identification (RFID) technology provides the ability to track individual items through a supply chain from a manufacturer to the consumer. However, the ability to tag individual items can be limited in some circumstances. First, the ability to physically tag individual items can be limited. Although relatively large items can be easily tagged using RFID technology, the physical space on smaller items is often limited, making tagging difficult or impossible. One solution proposed is the use of RFID ink technology, which allows an RFID tag to be printed on a small object. Printed RFID tags can be used on the surface of a syringe, for example, or any other object with a small surface area. However, even if tagging is possible, tagging may be undesirable, as it can affect the usage of the item. For example, some medical instruments and pharmaceutical products are often small, affording no space for an RFID tag. Additionally, because of sterility or purity requirements, it is not desirable to introduce any foreign substances or sources contaminants, such as RFID ink, onto these types of objects. Second, cost is an issue for tagging smaller items. For an item with high production costs, the additional costs associated with incorporating an RF tag are often inconsequential. However, for many smaller items, the cost of the RF tag can often exceed the cost of producing the item, resulting in an increased cost for the item. Therefore, while such items are generally untagged, it is still desirable to keep track of these items in the supply chain.

As a result of the inability and/or the impracticability of tagging small items, performing an inventory or audit of the quantity of such items is generally a time-consuming manual process, which can be error prone and/or increase production and delivery costs for the items. Additionally, as the number of small items flowing through a supply chain increases, manually verifying quantities of a variety of items can become a costly and cumbersome process. One solution has been to limit the number of items stored in a container, seal and tag the container through the supply chain, and only ship sealed containers through the supply chain. While this solution eliminates the need to manually audit the contents of containers, in some cases it may be desired or required to add or remove items from a container while the container moves through in the supply chain. As a result, the only method to accurately ascertain the quantity of items in a container is manual verification of the items in the container, increasing costs and complexity for the items in the supply chain. Another possible solution is to maintain a centralized database associating item quantities with containers, where the database can be updated whenever a quantity in a container changes. However, this requires a interrogation of the RFID tag of the container each time an item is added or removed. This would require any personnel who might be adding or removing items from a container to have an RFID reader and/or terminal to update the quantity information in a database, further increasing costs, complexity, and equipment needed for the items to travel through the supply chain.

Therefore, there is a need for systems and methods for automating the inventorying or audit process for ascertaining the quantities of small objects traveling in RFID tagged containers through a supply chain. More particularly, there is a need for such systems and methods that do not rely on manual verification of RFID tags.

### SUMMARY OF THE INVENTION

The present invention provides for automating the inventorying and tracking of small items by tagging the container in which they are placed with an radio frequency identification (RFID) inventory device that identifies the current number of items stored in the container. The RFID inventory device incorporates one or more sensors to detect the addition or removal of items from the container and can update a memory element within the RFID inventory device by incrementing or decrementing an item count accordingly. Upon interrogation by an RFID reader device, the RFID inventory device allows access not only to identification information for the container, but also to the present count of items in the container.

One embodiment of the invention is an RFID inventory device attached to a container for tracking quantities of objects stored in the container. Each RFID inventory device can consist of an antenna, supporting wireless interrogation by an external reader, an RFID chip coupled to the antenna having an embedded unique identifier and a memory element, where the RFID chip is adapted to store in the memory element at least one quantity value associated with the objects stored in the container. The RFID chip can further be adapted to allow the reader to wirelessly collect said identifier and the stored quantity values in response to a wireless interrogation. The RFID inventory device can also include one or more sensors coupled to the RFID chip, where the sensors are configured to send signals to the RFID chip in response to a change in quantities of objects in the container. The RFID chip can also be configured to automatically update at least one quantity value stored in said memory element in response to a signal from one or more sensors.

Another embodiment of the invention is method for updating quantity values of an RFID inventory device associated with a container for storing objects. The method can include the step of sending at least one signal from the sensors in the container to an RFID chip of the RFID inventory device in response to a change in quantity of objects stored in the container. The method can also include the step of updating at least one quantity value associated with the quantity of objects stored in the container in a memory element of the RFID chip in response to receiving a signal. The RFID chip can be coupled to an antenna, supporting wireless interrogation to allow a reader to wirelessly collect an embedded unique identifier of the RFID chip and at least one quantity value stored in the memory element in response to the wireless interrogation

Another embodiment of the invention is a computer-readable storage, having stored thereon a computer program having a plurality of code sections executable by a computer for causing the computer to perform the steps of receiving at least one signal from one or more sensors of a container for storing objects in response to a change in quantities of objects stored in the container, updating at least one quantity value in a memory element associated with quantities of objects stored in the container in response to receiving at least one signal, receiving at least one wireless interrogation from an external reader using an antenna, and transmitting a response to the wireless interrogation, where the response includes an embedded unique identifier and at least one quantity value.

In some embodiments, the sensor can consist of one or more activating devices coupled to one or more corresponding signaling devices; where the activating devices are configured to respond to a change in the quantities of objects stored in the container and activate said corresponding signaling devices. In some embodiments, a signal produced by at a first signaling device can different from a signal produced by a second signaling device.

In some embodiments, the activating devices can be adapted to respond automatically to changes in quantities of items. In some embodiments, an update to the memory element is not made until the occurrence of an update event. In other embodiments, user activation of the activating device is needed to make changes in the quantities of objects.

In some embodiments, at least one of the activating devices can consist of a mechanical switch, a pressure sensitive device, or a photo-detector switch. In other embodiments, at least one sensor can consist of an RFID sensor, where the RFID sensor is configured to send a signal to an RFID chip to response to a change in the quantity of objects stored in the container responding to a wireless interrogation from the RFID sensor.

Other embodiments, when configured in accordance with the inventive arrangements disclosed herein, can include methods or computer-readable storage medium having computer code for performing the various processes and processes disclosed herein.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic view of a radio frequency identification (RFID) inventory device according to one embodiment of the present invention.

FIG. 2 is a schematic view of a container using an exemplary embodiment of a RFID inventory device, according to another embodiment of the present invention.

FIG. 3(a) is a schematic view of a photo-detector device sensor arrangement for a RFID inventory device according to yet another embodiment of the present invention.

FIG. 3(b) is a schematic view of a mechanical device sensor arrangement a RFID inventory device, according to still another embodiment of the present invention.

FIG. 4 is a schematic view of a container using another exemplary embodiment of an RFID tag device, according to yet another embodiment of the present invention.

FIG. 5 is a schematic view of a container using another exemplary embodiment of an RFID tag device in accordance with the present invention.

FIG. 6 is a schematic view of an exemplary arrangement of containers using exemplary embodiments of RFID inventory devices in accordance with the present invention.

FIG. 7 is a schematic view of a photo-detector device sensor arrangement for a RFID inventory device in accordance with the present invention.

### DETAILED DESCRIPTION

With reference now to the various figures in which like elements are identically numbered throughout, a description of the various embodiments of the present invention will now be provided. While the invention is disclosed in the context of a single arrangement, it can be appreciated that the invention can include numerous modifications from the presented embodiment.

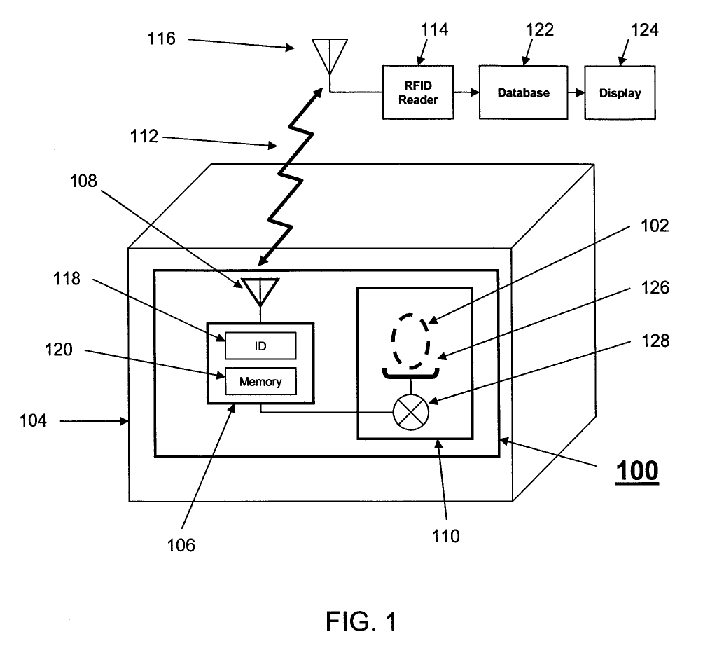

FIG. 1 depicts an exemplary schematic of a radio frequency identification (RFID) inventory device 100 for inventorying items or objects 102 stored in container 104. The inventory device 100 illustratively includes a RFID chip 106 coupled to an antenna 108 and at least one sensor 110. In the various embodiments, the antenna 108 is tuned to operate at a particular frequency and to support wireless interrogation 112 by a RFID reader 114 through a reader antenna 116. The RFID chip 106 can be configured to be responsive to the wireless interrogation 112, allowing the RFID reader 114 to access a unique identifier element 118 for the RFID chip 106 and a non-volatile memory element 120 of the RFID chip 106 to retrieve information stored therein. Although both the identifier element 118 and the memory element 120 are depicted as being integrated into a single RFID chip 106, it is to be understood that such an arrangement is for descriptive purposes only and that the arrangement of these elements in this and other embodiments of the inventory device 100 can vary without affecting functionality. In general, an RFID reader 114 can transfer the collected information to a remote database 122, where the information can be viewed by a user on a display 124 or otherwise processed or utilized. Although in the illustrated examples an RFID tag arrangement is used, the invention is not limited in this regard and any other type of affixed or detachable wireless transponder system or wireless computing system can also be used equivalently wherever an RFID device is discussed in this disclosure.

Conventionally, transponders and RFID tags are typically used only for identification purposes. In general, data associated with a container is normally stored only within a remote database. Even when a transponder is provided with a memory portion, in order to update or alter a field stored in the transponder, conventional techniques typically rely on an additional interrogation using an external read/write device. In the present invention, this interrogation step is no longer required and instead the one or more sensors 110 coupled to the RFID chip 106 can be configured to instruct or signal the RFID chip 106 to update the memory element 118 upon the addition or removal of an item 102 from a container 104.

The signal for the RFID chip 106 can be provided utilizing a sensor 110, as illustrated in FIG. 1, which can include at least one activating device 126 and one signaling device 128. In the various embodiments, the activating device 126 can be configured to respond to the addition or removal of at least one item from the container by activating or deactivating the signaling device 128. Once activated or deactivated, the signaling device 128 can be configured to transmit a signal to the RFID chip 106 which can be configured to instruct the RFID chip 106 to increment or decrement a count in the memory element 120. In some embodiments, the signal can be a direct instruction for the RFID chip 106. In other embodiments, the signal can be processed by the RFID chip 106 to determine whether or not to increment or decrement a count in the memory element 120. Although the signaling device 128 and the activating device 126 are depicted as being integrated into a single sensor 110, it is to be understood that such an arrangement is for logical purposes only and that the arrangement and placement of these devices in this and other embodiments of the inventory device 100 can vary without affecting functionality.

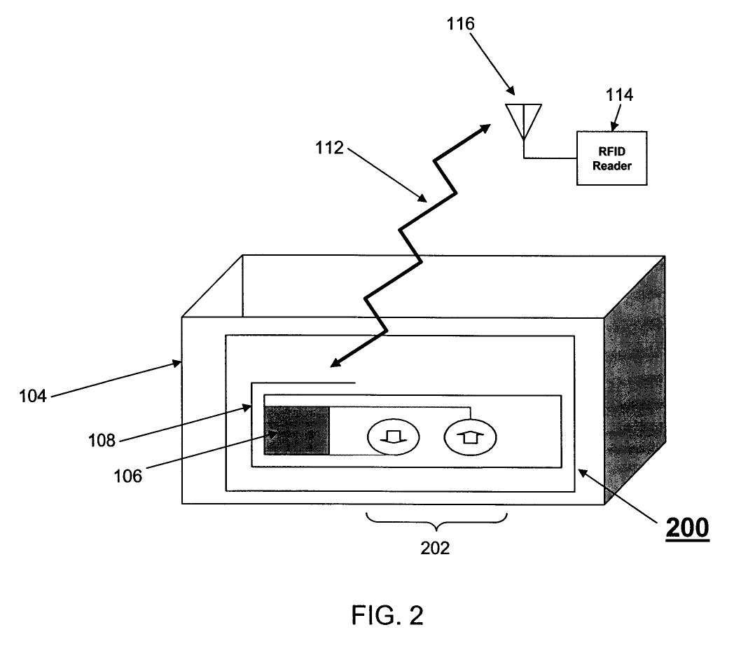

In the various embodiments, the method in which an activating device 126 can activate a signaling device 128 can vary. In some embodiments, as shown in FIG. 2, a RFID inventory device for inventorying items or objects 102 stored in container 104 can include a pair of buttons 202 coupled the RFID chip 106. In operation, each time a user removes or adds an item 102 to the container 104, the user depresses the corresponding one of the pair of buttons 202. The pair of buttons 202 can act as an activating device 126, activating a corresponding signaling device 128 which is configured to send a signal to the RFID chip 106 to alter a quantity value stored in the memory element 120. As shown in the exemplary arrangement in FIG. 2, an up arrow button and a down arrow button can be provided to increment and decrement the count in the memory element 120. In this and other embodiments, a small battery, a solar panel, or other compact power source can be used to provide the necessary electrical current for the RFID chip 106 to make changes to the memory element 120 and to support other functions of the RFID inventory device. Once the any change is made to the memory element 120, an external reader 114 can provide a wireless interrogation 112 and collect the currently stored count, along with the unique identifier associated with the container 104.

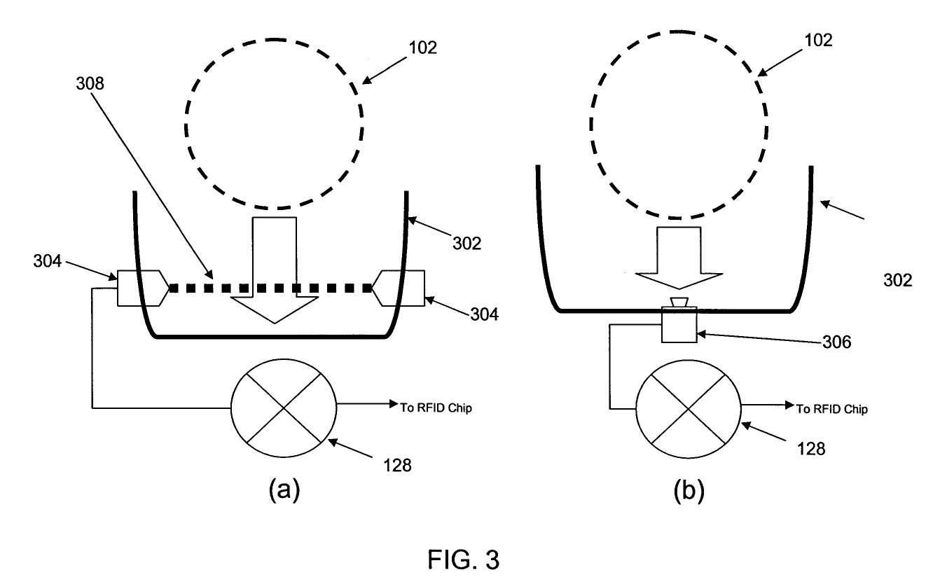

In some embodiments, the sensors 110 can be configured to signal the RFID chip 106 to automatically update the count upon detection of the addition or removal of an item from the container. For example, as illustrated in FIGS. 3(a) and 3(b), each item can reside in specific locations or slots 302 in the container 104. In at least one embodiment, the activating device 126 can comprise a photo-detector device 304, as illustrated in FIG. 3(a), or a mechanical device 306, as illustrated in FIG. 3(b). In either case, once the item 102 is inserted to the slot, the act of either breaking the beam 308, as shown in FIG. 3(a), or activating the mechanical device 306, as shown in FIG. 3(b) can be used to activate the signaling device 128 and to send a signal to the RFID chip 106 to increment the count stored. Similarly, when an item 102 is removed from a slot 302, the count can be decremented. In at least one embodiment, the termination of the signal from the signaling device 128 can be used by the RFID chip 106 to decrement the count stored. In the illustrated embodiment, activating devices 304, 306 are shown at the bottom of the slot 302. However the invention is not limited in this regard and a activating devices 304, 306 could be located elsewhere in the slot 302, depending on the items 102 stored and/or the container 104 type being used, and yet still provide the same functionality.

Additionally, as suggested by the illustrated examples in FIGS. 3(a) and 3(b), a container 104 can have multiple slots 302, each having at least one sensor 110 associated with the slot 302 and coupled to the RFID chip 104. In addition, the memory element 120 can be configured to further associate physical location with each of the sensors 110 used. With such an arrangement, not only is a total count of the items 102 within the container 104 provided, but also their arrangement within the container 104. In some circumstances, it can be desirable to rearrange the placement of items 102 in the container to distribute weight more evenly and provide greater stability for the container 106 and its contents while they are in transit through the supply chain.

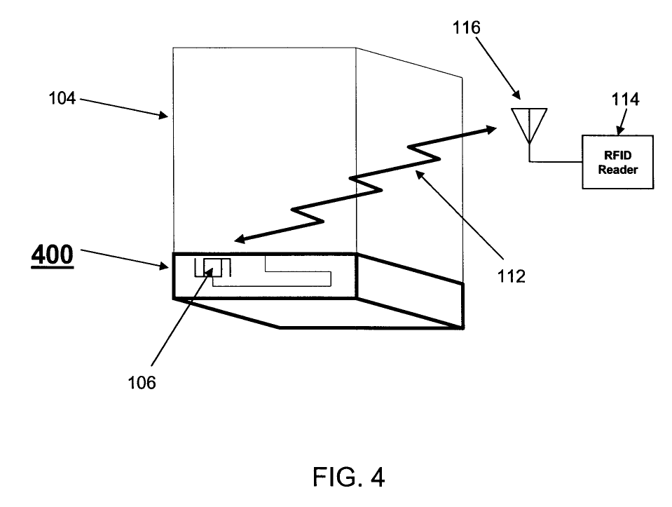

In other embodiments, the sensors 110 can also be configured to signal the RFID chip 106 to automatically update the count upon detection of a change in the weight of the container 104 or the items 102 stored therein, which can be associated with the addition or removal of an item 102 from the container 104. For, example, in FIG. 4, a RFID inventory device 400 for inventorying items or objects 102 stored in a container 104 can include a sensor 110 using as a scale or pressure sensitive device configured to send a signal to the RFID chip 106 based on changes in weight of the items 102 in the container 104.

As illustrated in FIG. 4, the bottom of the container can be configured to operate as the RFID inventory device by including a sensor 110 operating as a scale. In operation, each time an item 102 is placed into the container 104, the scale can register a change in the weight of the items 102 stored therein. The change in weight can be sent as a signal to the RFID chip 106, which can respond automatically by incrementing the count of items 102 based on the change in weight. Similarly, each time an item 102 is removed from the container 104, the reduction in weight can be transmitted as a signal to the RFID chip 106, which can respond automatically by decrementing the count of items 102 based on the reduction in weight. In the illustrated embodiment, the RFID chip 106 and antenna 108 are also located on the bottom portion of the container 104, however, it is to be understood that in other embodiments, the RFID chip 106 and the antenna 108 can be located elsewhere on the container to facilitate interrogation of the RFID inventory device 400.

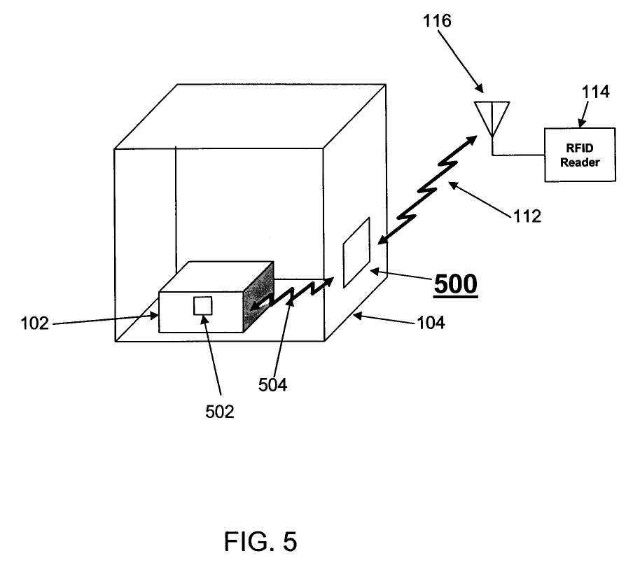

In yet other embodiments, as shown in FIG. 5, a RFID inventory device 500 for inventorying items or objects 102 stored in the container 104 can include a sensor comprising an internal RFID reader configured to wirelessly interrogate RFID tagged items or objects 102 stored therein. In such embodiments, the items stored 102 in the container 104 can have an RFID tag device 502 which can be interrogated by the inventory device 500. In operation, the inventory device 500 can update a count of items 102 in the memory element 120 based on successful wireless interrogation 504 of RFID tag devices 502 attached to items 102 stored therein. Therefore, based on the number of responses to the interrogation 504 by the inventory device 500, a corresponding count of items 102 can be updated in the memory element 102 of the RFID chip 106. In the various embodiments, a different frequency of operation for the external RFID reader 114 and the internal reader of inventory device 500 is preferred to ensure that the interrogation by external RFID reader 114 is limited to the inventory device 500 and not the contents stored within the container 104.

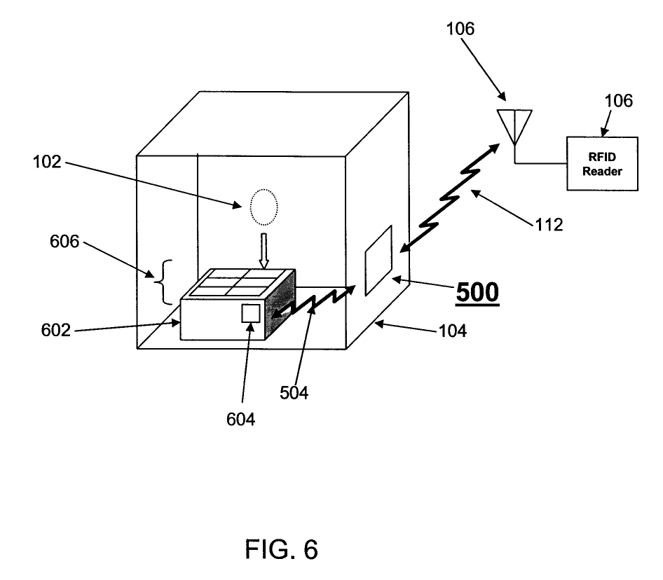

In some embodiments, as further shown in FIG. 6, an item stored within the container 104 can also be a sub-container 602 for one or more items 102. In the various embodiments, the sub-container 602 can comprise a container using an RFID inventory device 604 as described and illustrated in FIGS. 1-5. For example, as shown in the illustrated embodiment in FIG. 6, each item 102 can be inserted into a slot 606 of the sub-container 602, which can be configured to operate similarly to the exemplary arrangements illustrated and discussed in FIGS. 3(a) or 3(b). Similarly, an RFID inventory device 604 of the sub-container 602 can be configured to operate similar to the arrangement illustrated and discussed in FIG. 2, where a pair of buttons 202 could be used to manually increment and/or decrement the count each time an item 102 is added and/or removed from the sub-container 602. Alternatively, the RFID inventory device 604 for each sub-container 602 can further include a scale arrangement, as discussed and illustrated in FIG. 4, to provide an update count based on item 102 weight. Additionally, the RFID inventory device 604 of the sub-container 602 can further include an internal RFID reader, as described and illustrated in FIG. 5.

In the illustrated examples, the present invention has been discussed in terms of storing a collection of similar items, however the invention is not limited in this regard, and multiple types and sizes of objects could be stored and counted using the present invention. In some arrangements, multiple inventory devices can be used for different type of items, where sensors for each type of item are coupled to a corresponding inventory device. In other arrangements, multiple sensors can be coupled to an inventory device, where each sensor can be configured to detect a specific type of item stored in the container 104. Use of single RFID inventory device is advantageous in that a single RFID interrogation can be used to count a large number of items quickly and efficiently.

In such embodiments, the RFID chip 106 can be configured to stored multiple quantity values in the memory element 120 which can be collected by a RFID reader 114. In some embodiments, an inventory device 200 as illustrated in FIG. 2 could be configured with additional pairs of buttons 202 coupled to the RFID chip, where each additional pair of buttons 202 corresponds to a count of a specific type of item. For example, a container 104 can be used to store items 102 having different colors and each color could have an associated pair of buttons 202 which can be used to increment the count as items of each color are added or removed to the container 104. Similarly, additional pairs of buttons 202 can be provided for any type of classification desired.

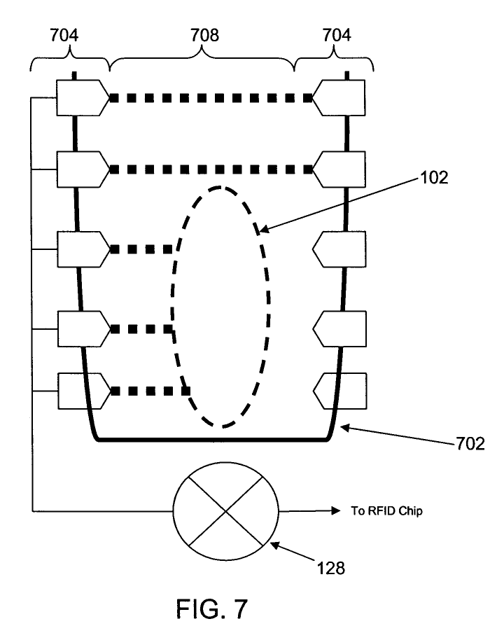

In another example, an inventory device can include one or more sensors 110 as illustrated in FIGS. 3(a) and 3(b). In such arrangements, different slots 302 can be designated for different types of items 102, such that when an item 102 is inserted into a slot 302 designated for a type of item 102, the RFID chip 106 can automatically update the count associated with the type of item 102. Alternatively, as shown in FIG. 7, multiple devices can be used to identify different types of objects stored within a slot 702. As illustrated in FIG. 7, multiple photo-detector switches 704 could be used to determine the size of the item 102 stored in a slot 702. In FIG. 7, a signal sent to the RFID chip 106 can be based on the number of beams 708 broken, which can be associated with different sizes of items 102 placed in slots 702. The signaling device 128 can then be configured to send a signal appropriate for the size of the item 102 and a corresponding count in the memory element 120 of the RFID chip 106 can be updated. Mechanical devices, as described and illustrated in FIG. 3(b) can be used to achieve the same functionality.

In another example, where an inventory device 400 as illustrated in FIG. 4 is used, the change in weight can correspond to a specific type of item 102 being added or removed from the container 104. In such arrangements, the sensor 110 and the RFID chip 106 can be configured to interpret a specific change in weight with a specific type of item 102. In some arrangements, multiple sensors 110, each using a pressure sensitive device can be used. For example, the mechanical device 306 of FIG. 3(b) can be configured as a pressure sensitive device, rather than a mechanical switch. In such arrangements, response of the device 306 to the weight of an item 102 placed in a slot 302 can be used to activate the signaling device 128 to transmit a signal appropriate for the weight of the item 102 to the RFID chip 106 in order to increment or decrement and appropriate count for a type of item in the memory element 120.

In another example, where an inventory device, as illustrated in FIG. 5, is used, information collected by the inventory device 500 from each RFID tag device 502 can include item type information. In such arrangements, this item type information can be used by the inventory device 500 to update an appropriate count in the memory element of the inventory device 500. Additionally, as shown in FIG. 6, a RFID tag device 604 of the sub-container 602 can also be updated with type information using any one of the methods previously described.

In the illustrated examples, the count in a memory element 120 of the RFID chip 106 has been described it terms of being automatically updated upon the addition or removal of an item. However, constant usage of power can be disadvantageous in some instances as the stored battery power can be expended prior to the container 104 reaching a final destination. Therefore, in some arrangements, an inventory device can be configured to update the count in the memory element 120 only after the occurrence of an update event, such as the passage of an interval of time. In these embodiments, the interval of time can be dependent on the level of inventorying needed by a user. For example, where only small amounts of items are removed on a regular basis from containers, a long interval can be provided, since instant inventorying of such items may not be needed. In another example, the interval of time can be based on the frequency of auditing of the containers 104. In cases where auditing is performed only several times a day, the count in the memory element may only be performed several times a day. In other arrangements, the update event can be the wireless interrogation itself and the inventory device can be configured to update the count only upon wireless interrogation by an external reader, further reducing continuous power consumption needs.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A radio frequency identification (RFID) inventory device for use with one or more containers, the device comprising:
an antenna supporting wireless interrogation by an external RFID reader;
a RFID chip coupled to said antenna having an embedded unique identifier and a memory element, wherein said RFID chip is adapted to store in said memory element at least one quantity value associated with said objects stored in said one or more containers, wherein said RFID chip is adapted to allow said external reader to wirelessly collect said identifier and said at least one quantity value in response to said wireless interrogation; and
one or more sensors coupled to said RFID chip, wherein said one or more sensors are configured to send at least one signal to said RFID chip in response to a change in said quantities of said objects in said one or more containers;
wherein said RFID chip is configured to update said at least one quantity value stored in said memory element in response to said at least one signal from said one or more sensors.

2. The device of claim 1, wherein said sensor comprises one or more activating devices coupled to one or more corresponding signaling devices, wherein said activating devices are configured to respond to a change in said quantities of objects stored in said one or more containers and activate said corresponding signaling devices.

3. The device of claim 1, wherein said sensor comprises one or more manual activating devices coupled to one or more corresponding signaling devices, wherein a manual activation of said manual activating devices by a user in response to a change in said quantities of objects stored in said one or more containers activates said corresponding signaling devices.

4. The device of claim 2, wherein at least one of said activating devices comprises at least one among a mechanical switch, a pressure sensing device, and a photo-detector device.

5. The device of claim 2, wherein a signal produced by at a first of said signaling devices is different from a signal produced by a second one of said signaling devices.

6. The device of claim 1, wherein at least one of said sensors comprises an RFID sensor, wherein said RFID sensor is configured to send a signal to said RFID chip to response to a change in said quantities of objects stored in said one or more containers responding to a wireless interrogation from said RFID sensor.

7. The device of claim 1, wherein said RFID chip is adapted to store said at least one quantity value only after the occurrence of an update event.

8. A method for updating at least one quantity value stored in an RFID inventory device associated with a container, the method comprising the steps of:
sending at least one signal from one or more sensors in said container to an RFID chip of said RFID inventory device in response to a change in quantities of objects stored in said container; and
updating at least one quantity value associated with said quantities of objects stored in said container in a memory element of said RFID chip in response to said RFID chip receiving said at least one signal.

9. The method of claim 8, wherein said sensor comprises one or more activating devices coupled to one or more corresponding signaling devices, wherein said activating devices are configured to respond to a change in said quantities of objects stored in said container and activate said corresponding signaling devices.

10. The method of claim 8, wherein said sensor comprises one or more manual activating devices coupled to one or more corresponding signaling devices, wherein a manual activation of said manual activating devices by a user in response to a change in said quantities of objects stored in said container activates said corresponding signaling devices.

11. The method of claim 9, wherein at least one of said activating devices comprises at least one among a mechanical switch, a pressure sensing device, and a photo-detector device.

12. The method of claim 9, wherein a signal produced by at a first of said signaling devices is different from a signal produced by a second one of said signaling devices.

13. The device of claim 8, wherein said RFID chip is adapted to update said at least one quantity value only after the occurrence of an update event.

14. The method of claim 8, wherein at least one of said sensors comprises an RFID sensor, wherein said RFID sensor is configured to send a signal to said RFID chip to response to a change in said quantities of objects stored in said container responding to a wireless interrogation from said RFID sensor.

15. A machine-readable storage, having stored thereon a computer program having a plurality of code sections executable by a machine for causing the machine to perform the steps of:
receiving at least one signal from one or more sensors of a container for storing objects in response to a change in quantities of objects stored in said container;
updating at least one quantity value in a memory element associated with said quantities of objects stored in said container in response to receiving said at least one signal;
receiving at least one wireless interrogation from an external reader using an antenna; and
transmitting a response to said at least one wireless interrogation, said response comprising an embedded unique identifier and said at least one quantity value.

16. The machine-readable of claim 15, wherein said sensor comprises one or more activating devices coupled to one or more corresponding signaling devices, wherein said activating devices are configured to respond to a change in said quantities of objects stored in said container and activate said corresponding signaling devices.

17. The machine-readable of claim 15, wherein said sensor comprises one or more manual activating devices coupled to one or more corresponding signaling devices, wherein a manual activation of said manual activating devices by a user in response to a change in said quantities of objects stored in said container activates said corresponding signaling devices.

18. The machine-readable of claim 16, wherein at least one of said activating devices comprises at least one among a mechanical switch, a pressure sensing device, and a photo-detector device.

19. The method of machine-readable 16, wherein a signal produced by at a first of said signaling devices is different from a signal produced by a second one of said signaling devices.

20. The machine-readable of claim 15, wherein at least one of said sensors comprises an RFID sensor, wherein said RFID sensor is configured to send a signal in response to a change in said quantities of objects stored in said container responding to a wireless interrogation from said RFID sensor.
